(19) United States
(12) Patent Application Publication
(10) Pub. No.: US 2019/0052745 A1
(43) Pub. Date: Feb. 14, 2019

(54) Method For Presenting An Interface Of A Remote Controller In A Mobile Device

(71) Applicant: Hisense Mobile Communications Technology Co., Ltd., Qingdao (CN)

(72) Inventors: Jin WU, Qingdao (CN); Xiaoming SUN, Qingdao (CN); Jing LI, Qingdao (CN); Qiang ZHANG, Qingdao (CN)

(21) Appl. No.: 16/161,854

(22) Filed: Oct. 16, 2018

Related U.S. Application Data
(63) Continuation of application No. PCT/CN2018/106583, filed on Sep. 19, 2018.

(30) Foreign Application Priority Data
Jun. 14, 2018 (CN) 201810615439.3

(51) Int. Cl. H04M 1/725; H04N 21/422; G08C 17/02; G06F 3/0481; G06F 3/0484

(52) U.S. Cl. CPC H04M 1/72533; H04N 21/4222; G08C 2201/93; G06F 3/04817; G06F 3/04842; G08C 17/02

(57) ABSTRACT

The invention discloses a method for presenting an interface of a remote controller in a mobile device. The method includes: receiving, by the mobile device, a display instruction to display an interface of a remote controller matching with an electronic device, wherein the mobile device is in electrical connection with the electronic device; and in response to the display instruction, displaying the interface of the remote controller for controlling the electronic device on a display screen of the mobile device, where the interface of the remote controller includes interface elements for controlling the electronic device.

### CROSS-REFERENCE TO RELATED APPLICATIONS

This application is a continuation of PCT International Application No. PCT/CN2018/106583 filed Sep. 19, 2018, which claims the benefit and priority of Chinese Patent Application No. 201810615439.3, filed Jun. 14, 2018. The entire disclosures of the above applications are incorporated herein by reference.

### FIELD

The present disclosure relates to information technologies, and particularly to a method for presenting an interface of a remote controller in a mobile device.

### BACKGROUND

This section provides background information related to the present disclosure which is not necessarily prior art.

At present, there are a series of home appliances including a TV set, an air conditioner, a set-top box, etc., in more and more houses, and each home device is controlled by its specific remote controller, so a user has to control the home device only after he or she finds the matching remote controller.

Accordingly there is a desire to provide such an operation shortcut for a user, which uses a widely applied mobile device to enable the user to control home devices conveniently.

### SUMMARY

This section provides a general summary of the disclosure, and is not a comprehensive disclosure of its full scope or all of its features.

This disclosure provides a method for presenting an interface of a remote controller in a mobile device so as to make it convenient for a user to control rapidly a home device to be used by the user, thus improving the experience of the user.

In a first aspect, the disclosure discloses a method for presenting an interface of a remote controller in a mobile device, the method including:

receiving, by the mobile device, a display instruction to display an interface of a remote controller matching with an electronic device, wherein the mobile device is in electrical connection with the electronic device; and

in response to the display instruction, displaying the interface of the remote controller for controlling the electronic device on a display screen of the mobile device, wherein the interface of the remote controller includes interface elements for controlling the electronic device.

In a second aspect, the disclosure discloses a method for presenting an interface of a remote controller in a mobile device, the method including:

obtaining a picture of an electronic device;

identifying feature information of the electronic device in the picture;

checking a selection of feature information pre-stored in the mobile device for a match with the feature information of the electronic device; and

displaying an interface of a remote controller for controlling the electronic device on a display screen of the mobile device according to the match with the feature information of the electronic device.

In a third aspect, the disclosure discloses a mobile device including:

a display screen;

a processor; and

a memory configured to store computer instructions executable by the processor;

wherein the processor is configured to execute the computer instructions to cause the mobile device to:

receive a display instruction to display an interface of a remote controller matching with an electronic device, wherein the mobile device is in electrical connection with the electronic device; and

in response to the display instruction, display the interface of the remote controller for controlling the electronic device on a display screen of the mobile device, wherein the interface of the remote controller includes interface elements for controlling the electronic device.

In a fourth aspect, the disclosure discloses a mobile device, including:

a display screen;

a processor; and

a memory configured to store processor computer instructions executable by the processor;

wherein the processor is configured to execute the computer instructions to cause the mobile device to:

obtain a picture of an electronic device;

identify feature information of the electronic device in the picture;

checking a selection of feature information pre-stored in the mobile device for a match with the feature information of the electronic device; and

display an interface of a remote controller for controlling the electronic device on a display screen of the mobile device according to the match with the feature information of the electronic device.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a block diagram of a mobile device according to an embodiment of this disclosure.

FIG. 2 shows a flow chart of a method for presenting an interface of a remote controller in a mobile device according to an embodiment of this disclosure.

FIG. 3 shows a schematic diagram of an entry to an interface of a remote controller to be displayed on a display screen.

FIG. 4 shows a schematic diagram of the interface of the remote controller displayed on the display screen.

FIG. 5 shows a flow chart of a method for presenting an interface of a remote controller in a mobile device according to another embodiment of this disclosure.

Corresponding reference numerals indicate corresponding parts or features throughout the several views of the drawings.

### DETAILED DESCRIPTION

Example embodiments will now be described more fully with reference to the accompanying drawings.

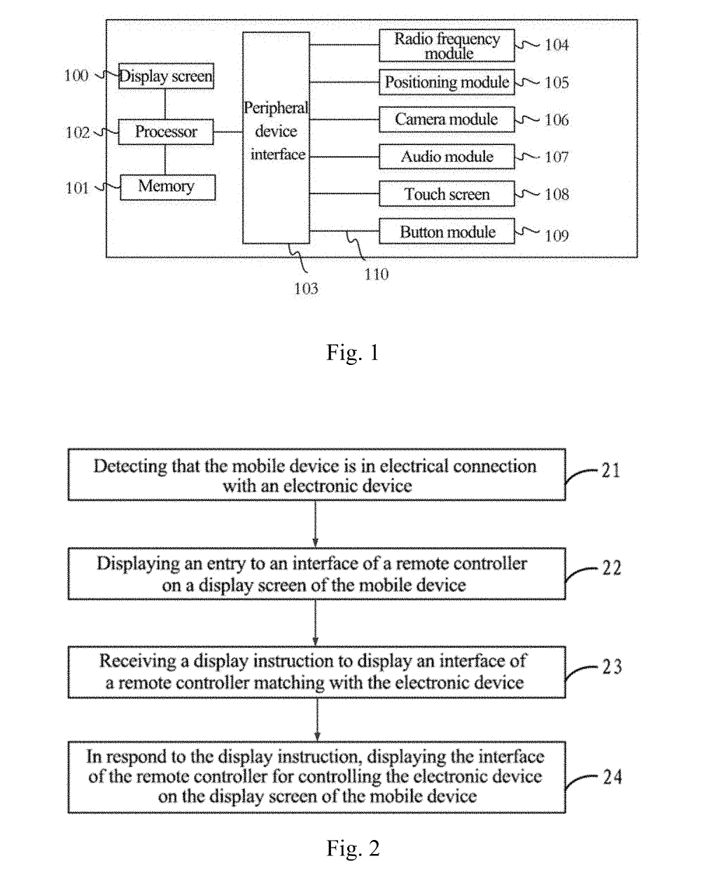

Referring to FIG. 1, it is a block diagram of a mobile device according to an embodiment of this disclosure. It shall be noted that the mobile device is only an example of this disclosure, but not intended to limit the scope of this disclosure thereto. The mobile device shall not be interpreted as depending upon or requiring one or more of components in the mobile device in the example as illustrated in FIG. 1.

As illustrated in FIG. 1, the mobile device includes a display screen 100, a memory 101, one or more (only one as illustrated) processors 102, a peripheral device interface 103, a radio frequency module 104, a positioning module 105, a camera module 106, an audio module 107, a touch screen 108, and a button module 109. These components communicate with each other through one or more communication buses/signal lines 110.

In some embodiments, the display screen 100 is a liquid crystal screen or e-ink screen.

In some embodiments, the display screen 100 includes two screens, where one screen is a liquid crystal screen, and the other screen is an e-ink screen. Of course, as an alternative, the display screen 100 includes only one screen, and the screen can be a liquid crystal screen or e-ink screen.

The memory 101 is configured to store software program and modules, e.g., program instructions and modules corresponding to a method for presenting an interface of a remote controller in a mobile device according to an embodiment of this disclosure, and the processor 102 is able to execute the program instructions stored in the memory 101 to perform various functions and data processing, i.e., to perform the method for presenting an interface of a remote controller in a mobile device.

The memory 101 which is a resource storage carrier is a random storage medium, e.g., a high-speed random memory, a non-transitory memory, e.g., one or more magnetic storage devices, flash memories, or other solid-state memories, etc. The storage can be temporary storage or permanent storage.

The peripheral device interface 103 includes at least one wired or wireless network interface, at least one serial to parallel conversion interface, at least one input-output interface, at least one USB interface, etc., configured to couple various external input and output devices with the memory 101 and the processor 102 so as to communicate with the various external input and output devices.

The radio frequency module 104 is configured to transmit and receive an electromagnetic wave, and to convert the electromagnetic wave into an electric signal, and the electric signal into the electromagnetic wave, to thereby communicate with another device over communication network. The communication network includes cellular network, WLAN (Wireless Local Area Network), or MAN (Metropolitan Area Network), and the communication network can operate under various communication standards, protocols, and technologies.

The positioning module 105 is configured to obtain the current geographical position of the mobile device. An example of the positioning module 105 includes but not limited to a Global Positioning System (GPS), a wireless local area network or mobile communication network enabled positioning technology, etc.

The camera module 106 in a camera is configured to take a picture or a video. The picture or video can be stored in the memory 101, and can be further transmitted to an upper computer through the radio frequency module 104.

The audio module 107 is configured to provide a user with an audio interface, and includes one or more microphone interfaces, one or more speaker interfaces, and one or more earphone interfaces. The audio module can exchange audio data with another device via the audio interface. The audio data can be stored in the memory 101, and can be further transmitted through the radio frequency module 104.

The touch screen 108 provides an input-output interface between the mobile device and the user. In some embodiments, the user can perform an input operation, e.g., clicking, touching, sliding, or another gesture operation, on the touch screen 108 so that the electronic device responds to the input operation. The mobile device displays output content in any one or combination of a text, a picture, or a video to the user on the touch screen 108.

The button module 109 includes at least one button, and is configured to provide an interface via which the user provides an input to the mobile device, so that the user can press down a different button to enable the mobile device to perform a different function. For example, the user can press down a volume adjustment button to adjust a volume of sound played by the mobile device.

As can be appreciated, the structure as illustrated in FIG. 1 is only illustrative, but the mobile device can further include more or less components than those as illustrated in FIG. 1, or other components than those as illustrated in FIG. 1. The respective components as illustrated in FIG. 1 can be embodied in hardware, software, or both.

In order to make it convenient for the user to use the mobile device to control rapidly an electronic device to be used by the user, the inventors have identified that one can make full use of the characteristic of a desktop navigation bar area to conveniently operate on the mobile device so that a shortcut entry to an application or a function interface is displayed dynamically in the navigation bar area, e.g., current reminders (rainstorm, a train schedule, credit card repayment, etc.), the most frequently accessed applications (e.g., XX application, YY application, etc.) at the current time, or some function interface (for example, if it is detected that the mobile device has been connected successfully with a TV set in a WiFi environment, then a reminder, or an interface of a remote controller for controlling the TV set will be displayed automatically), so the user can click on and access directly the application or some function interface instead of sliding on and searching the desktop, thus improving the experience of the user.

FIG. 2 shows a flow chart of a method for presenting an interface of a remote controller in a mobile device according to an embodiment of this disclosure. As illustrated in FIG. 2, the method is performed by the mobile device as illustrated in FIG. 1, and includes but not limited to the following operations.

Operation 21, detecting that the mobile device is in electrical connection with an electronic device.

In some embodiments, when the mobile device accesses WIFI successfully, the mobile device will search the local area network for the electronic device accessing the local area network on its own initiative, through Digital Living Network Alliance (DLNA) technology. After the electronic device is searched out, the mobile device obtains the IP address and description information of the electronic device, where the description information of the electronic device includes at least device type (e.g., a TV set, a set-top box, an air conditioner, etc.), device brand, device model, the infrared support flag of the electronic device, etc.

It should be noted that in the case that both the mobile device and the electronic device support an infrared function, the mobile device can exchange information with another electronic device through the infrared function. Typically it can be determined from the infrared support flag in the description information of the electronic device whether the electronic device supports the infrared function.

In some embodiments, when both the mobile device and the electronic device support the infrared function, the mobile device acquires infrared device information pre-stored in the mobile device, and if the acquired description information of the electronic device matches with the infrared device information pre-stored in the mobile device, it is determined that the mobile device is bound with the electronic device; or the mobile device acquires an infrared device code database pre-stored in the mobile device, traverses infrared device coded parameters according to the acquired description information of the electronic device until the electronic device responds, and determines an infrared coded parameter corresponding to the electronic device (e.g., channel up/down, volume up/down, etc.), then it is determined that the mobile device is bound with the electronic device.

In some embodiments, when the mobile device does not support the infrared function, the mobile device is bound with the electronic device using their IP addresses, and furthermore information is exchanged through their WiFi modules.

Furthermore in the case that both the mobile device and the electronic device support a Near Field Communication (NFC) function, enabling their NFC functions, moving the mobile device proximate to the electronic device, and if the mobile device can operate the electronic device, then it is determined that the mobile device is bound with the electronic device.

Operation 22, displaying an entry to an interface of a remote controller on a display screen of the mobile device.

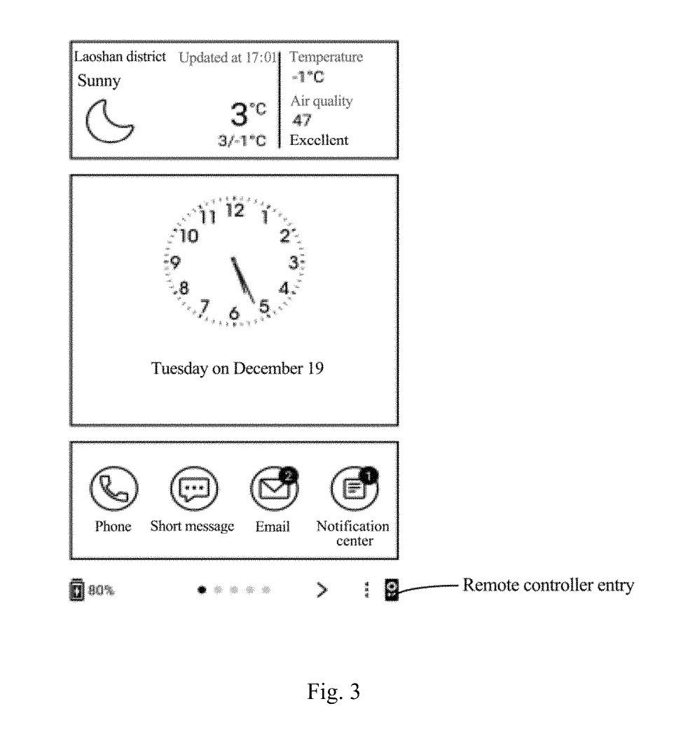

In some embodiments, when the mobile device is electronically connected with the electronic device, as illustrated in FIG. 3, the entry to the interface of the remote controller (represented as a remote controller entry as illustrated) can be displayed in a desktop navigation bar area on the display screen of the mobile device to tell the user that there is currently an electronic device connected successfully with the mobile device, and one can access the interface of the remote controller for controlling the electronic device. Of course, alternatively rainstorm, a train schedule, or another reminder, or the frequently accessed application can be displayed in the navigation bar area.

Here when the display screen of the mobile device is an e-ink screen, information is displayed on the ink screen using reflected light rays instead of transmitted light rays, so that the information can be displayed naturally under any illumination, locked-screen, or powered-off condition. In this way, when the mobile device is connected successfully with the electronic device, the entry to the interface of the remote controller is displayed in the desktop navigation bar area on the ink screen to thereby make it more convenient to tell the user without unlocking the liquid crystal screen.

In some embodiments, the entry to the interface of the remote controller displayed on the display screen is a remote controller icon, and in some embodiments, the remote controller icon can match with the type or the model in the description information of the electronic device, and for example, if a brand 1 TV set is connected with the mobile device, then a remote controller icon matching with the brand 1 TV set will be displayed on the display screen, and if a brand 2 air conditioner is connected with the mobile device, then a remote controller icon matching with the brand 2 air conditioner will be displayed on the display screen.

Operation 23, receiving a display instruction to display an interface of a remote controller matching with the electronic device.

In some embodiments, the display instruction is generated by operating on an application icon in an interaction interface of the mobile device. In some embodiments, the application icon in the interaction interface of the mobile device is the entry to the interface of the remote controller, e.g., the remote controller icon as described in the embodiments above.

Operation 24, in respond to the display instruction, displaying the interface of the remote controller for controlling the electronic device on the display screen of the mobile device.

In some embodiments, interface layouts of the remote controllers of the electronic devices are pre-stored in the mobile device or a backend server. An interface layout of a remote controller matching with the electronic device is searched out according to the obtained description information of the electronic device; and the interface of the remote controller is displayed on the display screen based upon the interface layout of the remote controller.

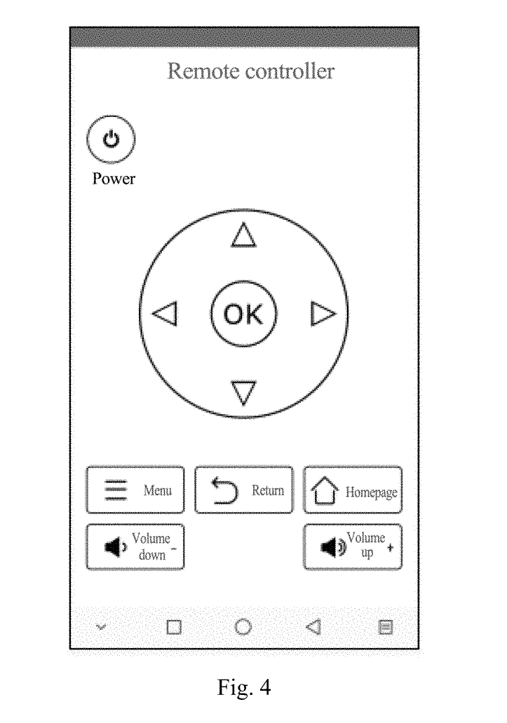

In some embodiments, the interface of the remote controller includes interface elements for controlling the electronic device, and the interface elements include general buttons of the remote controller. As illustrated in FIG. 4, the interface of the remote controller can include general buttons of the remote controller, e.g., a power button, a menu button, direction buttons, etc.

Here the obtained description information of the electronic device can also be converted into control information for controlling the electronic device, and furthermore an interface of a remote controller matching with the control information can be displayed on the display screen.

Furthermore the user operates on the interface of the remote controller, and information is exchanged and data are transmitted through the infrared functions or the WiFi modules of the mobile device and the electronic device, so that the user controls the electronic device through the interface of the remote controller.

In this embodiment, after the mobile device detects the connected electronic device, the entry to the interface of the remote controller for controlling the electronic device is displayed on the mobile device; and when the entry to the interface of the remote controller is operated on so that the mobile device receives the display instruction to display the interface of the remote controller, the interface of the remote controller is displayed for the user to control the electronic device, so that the user can operate conveniently on the interface of the remote controller displayed on the mobile device without looking for the remote controller matching with the electronic device.

Furthermore the inventors have identified that the user typically looks for the remote controller of the electronic device only when he or she is going to use the electronic device, so the user can obtain a picture of the electronic device to be used by the user through the mobile device on his or her own initiative, and after the electronic device in the picture is identified, the interface of the remote controller matching with the electronic device can be displayed directly for the user to operate on.

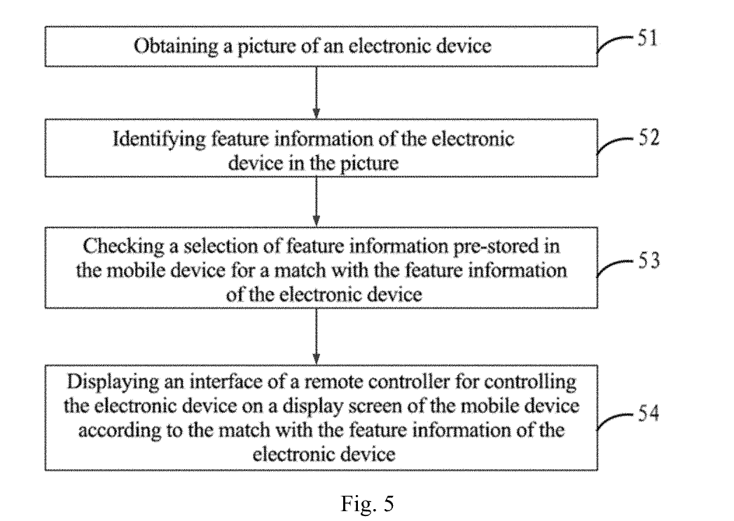

FIG. 5 shows a flow chart of a method for presenting an interface of a remote controller in a mobile device according to another embodiment of this disclosure. As illustrated in FIG. 5, the method can be performed by the mobile device as illustrated in FIG. 1, and include but not limited to the following operations.

Operation 51, obtaining a picture of an electronic device.

Operation 52, identifying feature information of the electronic device in the picture.

In some embodiments, when a user is going to use the electronic device, the electronic device is photographed using the mobile device, and image recognition is performed on the picture obtained by photographing to thereby identify the feature information of the electronic device in the picture. In some embodiments, the feature information of the electronic device includes one or more of: device type, device brand, and device model. For example, when a brand 1 TV is photographed using a mobile phone, the picture obtained by photographing includes an image of the TV set, where there is a logo of the TV set in a specific area (e.g., a lower area of the picture) of the picture, and the brand of the TV set is determined from the logo. In another example, when a brand 2 air conditioner is photographed using a mobile phone, the picture obtained by photographing includes the air conditioner, where there are a logo and a model of the air conditioner in a specific area (e.g., a middle area of the picture) of the picture, and the brand of the air conditioner is determined from the logo.

Operation 53, checking a selection of feature information pre-stored in the mobile device for a match with the feature information of the electronic device.

Operation 54, displaying an interface of a remote controller for controlling the electronic device on a display screen of the mobile device according to the match with the feature information of the electronic device.

Feature information of electronic devices, e.g., images, brands, models etc., of a TV set, an air conditioner, a set-top box, and other electronic devices, is pre-stored in the mobile device or a backend server. The feature information of the electronic device identified from the picture is matched with a selection of feature information pre-stored to find a match with the feature information of the electronic device, whose match degree is greater than a predefined value. The match is further determined as the electronic device to be used by the user, the match's feature information is determined as the feature information of the electronic device, so that the interface of the remote controller for controlling the electronic device is displayed on the display screen of the mobile device.

Next the interface of the remote controller for controlling the electronic device is displayed on the display screen of the mobile device based upon an interface layout of a remote controller matching with the electronic device, or control information for controlling the electronic device as illustrated in FIG. 4. In some embodiments, the user operates on the interface of the remote controller, and information is exchanged and data are transmitted through infrared functions or WiFi modules of the mobile device and the electronic device, so that the user controls the electronic device through the interface of the remote controller.

In the embodiments of this disclosure, the mobile device obtains on its own initiative the picture of the electronic device to be used by the user, and after the electronic device in the picture is recognized, the interface of the remote controller matching with the electronic device is displayed directly so that the user controls the electronic device by operating on interface elements (general buttons of a remote controller, e.g., a power button, a menu button, direction buttons, etc.) on the interface of the remote controller. In this way, the user can operate conveniently on the interface of the remote controller displayed on the mobile device directly without looking for the remote controller matching with the electronic device.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for presenting an interface of a remote controller in a mobile device, the method comprising:
receiving, by the mobile device, a display instruction to display an interface of a remote controller matching with an electronic device, wherein the mobile device is in electrical connection with the electronic device; and
in response to the display instruction, displaying the interface of the remote controller for controlling the electronic device on a display screen of the mobile device, wherein the interface of the remote controller comprises interface elements for controlling the electronic device.

2. The method according to claim 1, wherein the electronic device is one or more of a TV set and an air conditioner.

3. The method according to claim 1, wherein the display screen of the mobile device is an e-ink screen.

4. The method according to claim 1, wherein the method further comprises:
upon detecting the mobile device and the electronic device being in a same local area network, obtaining an IP address of the mobile device, and an IP address of the electronic device, and establishing a connection between the electronic device and the mobile device through the IP address of the electronic device and the IP address of the mobile device.

5. The method according to claim 1, wherein the method further comprises:
upon detecting the mobile device and the electronic device being in a same local area network, obtaining description information of the electronic device;
determining whether the description information of the electronic device matches with infrared device coded parameters pre-stored in the mobile device, and
in response to the description information of the electronic device matching with the infrared device coded parameters pre-stored, determining that the mobile device is in electrical connection with the electronic device.

6. The method according to claim 5, wherein the displaying the interface of the remote controller for controlling the electronic device on the display screen of the mobile device comprises:
searching for an interface layout of the remote controller matching with the electronic device according to the description information of the electronic device; and
displaying the interface of remote controller on the display screen of the mobile equipment based upon the interface layout of the remote controller.

7. The method according to claim 1, wherein the display instruction is generated by operating on an application icon in an interaction interface of the mobile device.

8. A method for presenting an interface of a remote controller in a mobile device, the method comprising:
obtaining a picture of an electronic device;
identifying feature information of the electronic device in the picture;
checking a selection of feature information pre-stored in the mobile device for a match with the feature information of the electronic device; and
displaying an interface of a remote controller for controlling the electronic device on a display screen of the mobile device according to the match with the feature information of the electronic device.

9. The method according to claim 8, wherein the feature information of the electronic device comprises one or more of: device type, device brand, and device model.

10. The method according to claim 9, wherein the picture comprises a logo of the electronic device, and the device brand is identified based on the logo.

11. The method according to claim 8, wherein the picture is obtained by photographing of the mobile device.

12. The method according to claim 8, wherein checking the selection of feature information pre-stored in the mobile device for the match with the feature information of the electronic device comprises:
checking the feature information of the electronic device and the selection of the preset feature information in the mobile device to determine one with matching degree greater than a predefined value as the match with the feature information of the electronic device.

13. A mobile device, comprising:
a display screen;
a processor; and
a memory configured to store computer instructions executable by the processor;
wherein the processor is configured to execute the computer instructions to cause the mobile device to:
receive a display instruction to display an interface of a remote controller matching with an electronic device, wherein the mobile device is in electrical connection with the electronic device; and
in response to the display instruction, display the interface of the remote controller for controlling the electronic device on a display screen of the mobile equipment, wherein the interface of the remote controller comprises interface elements for controlling the electronic device.

14. A mobile device, comprising:
a display screen;
a processor; and
a memory configured to store computer instructions executable by the processor;
wherein the processor is configured to execute the computer instructions to cause the mobile device to perform the method of claim 8.
